(19) United States
(12) Patent Application Publication
(10) Pub. No.: US 2011/0111202 A1
(43) Pub. Date: May 12, 2011

(54) MULTILAYER FILM STRUCTURE, AND METHOD AND APPARATUS FOR TRANSFERRING NANO-CARBON MATERIAL

(75) Inventors: Ching-Yuan Su, Taichung County (TW); Ang-Yu Lu, Taichung City (TW); Zhen-Yu Juang, Hsinchu City (TW); Keh-Chyang Leou, Hsinchu City (TW); Chuen-Horng Tsai, Hsinchu City (TW)

(73) Assignee: NATIONAL TSING HUA UNIVERSITY, Hsin-Chu (TW)

(21) Appl. No.: 12/704,005

(22) Filed: Feb. 11, 2010

(30) Foreign Application Priority Data
Nov. 12, 2009 (TW) 098138496

(51) Int. Cl. B32B 5/18; B32B 9/00; B32B 15/04; C23F 1/00; C23F 1/08

(52) U.S. Cl. 428/312.6; 428/688; 428/457; 428/408; 216/33; 156/345.11; 977/742

(57) ABSTRACT

The invention discloses a method and apparatus for transferring nano-carbon material. The nano-carbon material is grown, by chemical vapor deposition, on a catalyst layer provided between a first and a second oxide layer of a multilayer film structure grown on a first substrate through chemical vapor deposition, and then separated from the first substrate by etching away the first and second oxide layers by a wet etching process. The separated nano-carbon material floats on the etchant, and is then pulled up by an etch-resistant continuous conveyance device and transferred to a second substrate. And, in a further imprinting process, large area nano-carbon material can be continuously imprinted onto the second substrate to show a particularly designed pattern.

### FIELD OF THE INVENTION

The present invention relates to a multilayer film structure, and a method and apparatus for transferring nano-carbon material; and more particularly, to a method and apparatus for continuous transferring and patterned imprinting large area nano-carbon material from a first substrate onto a second substrate.

### BACKGROUND OF THE INVENTION

Transparent conductive material plays a very important role in the display and solar energy industries. Most of the common transparent conductive materials are n-type metal oxides, which provide high conductivity through oxygen vacancies in the structure thereof and doping of other ions or chemicals. Among others, indium tin oxide (ITO), due to its superior conductivity, has become an irreplaceable choice in the current display panel industry. However, since there is only limited indium resource on the earth, the cost of ITO target constantly increases in recent years. Further, reduced conductivity of the film of ITO occurs when ITO is bent, rendering ITO not suitable for flexible elements. Therefore, there is an imminent need for finding an alternative to ITO.

Since the carbon nanotube was discovered in 1991, a thin film of carbon nanotubes has been used as a transparent, flexible, electrically conductive and even light-emitting material due to its electric and optical properties. The thin film of carbon nanotubes has light transmittance of no less than 85% and 65% in terms of a polarized light parallel and vertical to the direction of carbon nanotubes, respectively. According to the prior art wet coating technique for forming single-layered carbon nanotubes developed by Eikos, Inc., when the coating thickness is less than about 100 nm, the single-layered carbon nanotubes have a sheet resistance of 50˜10000 Ohm per square, and a visible light transmittance of 80˜98%. The lower the sheet resistance is, the lower the light transmittance is. But the light transmittance does not vary a lot with the band of visible light. Therefore, it can be seen that the carbon nanotube is really an excellent alternative transparent electrode material either on a flexible or a rigid substrate.

The currently available techniques for producing thin film of carbon nanotubes include spin-coating, dip-deposition, vacuum filtration, airbrushing, electrophoretic deposition (EDP), and electrostatic precipitation (ESP).

The spin-coating is conventionally used in the solution-based film forming processes. In spin-coating, first disperse purified carbon nanotubes in a solution to form a uniform suspension. Then, use a spin-coating machine to drop the dispersion solution on a substrate, on which a film material is to be formed. The thickness of the film to be formed can be adjusted via the rotating speed of the spin-coating machine. In the dip-deposition, the substrate, on which a film material is to be formed, is completely dipped in the above-mentioned dispersion solution for a predetermined period of time. Then, the substrate is vertically pulled out of the solution for the carbon nanotubes to attach to the substrate. A film material is formed on the substrate after the same is dried. In both of the spin-coating and the dip-deposition, the carbon nanotubes require surface modification. In the past, a surfactant, such as sodium dodecyl sulfate (SDS), dimethyl formamide (DMF), or Triton X-100, is usually used to assist in the dispersion of the carbon nanotubes in the solution. However, the use of any of the above-mentioned surfactants would cause the problem of residual surfactant on the produced film. While the residual surfactant on the surface of the film can be removed with water, the residual surfactant left in the clearances below the surface could not be thoroughly removed to thereby adversely affect the electric performance of the produced film of carbon nanotubes.

In the vacuum filtration, a suspension of carbon nanotubes must be prepared first. Then, a filtration film with proper pore size is selected for use with a vacuum-pumping apparatus, so as to control the density and the thickness of the produced film material via the volume of the filtered carbon nanotube suspension. Thereafter, deionized water is used to rinse the produced film of carbon nanotubes, in order to remove any residual surfactant. Finally, the produced film of carbon nanotubes is air dried to obtain the final carbon nanotube film deposited on the filtration film. In 2004, Lim et al. allowed the polydimethylsiloxane (PDMS) to solidify on a filtration film, and then removed and imprinted the PDMS on a desired substrate. The above-described method is somewhat similar to the mechanical imprint, and the thin film is imprinted on the substrate utilizing the van der Waals force between the carbon nanotube film and the substrate. However, the above imprinting method has relatively low yield mainly because incomplete thin film tends to occur in the course of imprint process, that is, in the process of handling and pressing the thin film.

As the vacuum filtration, the airbrushing is also often used in recent years for preparing the carbon nanotube film. George Gruner and M. Kaempgen at University of California-Los Angeles are the first researchers developing the airbrushing process. In the airbrushing, an art airbrush with small-gauge nozzle is used to spray well-formulated suspension of carbon nanotubes. In this manner, it is possible to effectuate industrialized mass production of large area carbon nanotube film. Further, with airbrushing, the carbon nanotube film can be coated on a variety of substrates at room temperature. However, this process also has the problem of residual surfactant and encounters with the bottleneck of failing to precisely control the film thickness.

The electrophoretic deposition is frequently used in colloid coating. In 2006, Aldo et al. proposed the use of electrophoretic deposition to deposit a film of carbon nanotubes and analyze the property of the produced film of carbon nanotubes. The electrophoretic deposition includes two steps. First, a suspension of carbon nanotubes is prepared, in which charged carbon nanotubes are uniformly dispersed with the help of a surfactant, such as SDS, DMF or isopropylamine (IPA). Second, a voltage is applied to drive the charged carbon nanotubes in the suspension to move toward the electrode and deposit on a substrate. The charged carbon nanotubes will uniformly deposit on the conductive electrode to form a thin film of carbon nanotubes. However, in preparing the suspension solution, it is necessary to consider the possible modification or destruction of the intrinsic properties of the carbon nanotubes during the course of dispersion. Further, it is still necessary to check for any residual surfactant after deposition of the thin film.

In 2009, researchers at Helsinki University and Nokia Research's Nano-science Laboratory synthesized carbon nanotubes by aerosol methods, and utilized a suspension catalyst to grow carbon tubes when carbon monoxide was used as a carbon source gas. Then, carbon monoxide was used as a carrier gas to carry the carbon tubes to a low-temperature zone to carry out the step of precipitation using an electrostatic precipitator, so that a uniform netlike thin film of carbon nanotubes was formed on a rigid or a flexible substrate at room temperature. In the electrostatic precipitation, the step of growing the carbon tubes is particularly important. Since the process does not include a purifying step, the grown carbon tubes must have good quality to exactly avoid the growth of carbon tubes with a lot of structural defection or the growth of too much amorphous carbon.

From the above general description, it is found that all the five techniques for producing thin film of carbon nanotubes, except the electrostatic precipitation, require the step of dispersing carbon nanotubes in a solution to prepare a uniform suspension of carbon nanotubes. To prepare this uniform suspension, it is usually necessary for the carbon nanotubes to undergo supersonic oscillation and to obtain surface modification using a surfactant, so as to obtain highly uniform suspension. However, high-energy oscillation would destruct the carbon nanotube structure to shorten its length. Further, it is uneasy to thoroughly remove the residual surfactant from the pores among the carbon nanotubes. All these factors would have adverse influence on the electric or optical properties of the produced thin film of carbon nanotubes and therefore narrow the industrial applications thereof. While the vacuum filtration technique can solve the problem of residual surfactant, it does not allow for a variety of choices of substrates to thereby encounter a bottleneck in its application.

### SUMMARY OF THE INVENTION

In view of the problems existing in the prior art, it is therefore a primary object of the present invention to provide a multilayer film structure, and a method and apparatus for transferring nano-carbon material, so that large area film-like nano-carbon material can be quickly separated from a first substrate and transferred to a second substrate.

Another object of the present invention is to provide a method and apparatus for transferring nano-carbon material, so that the film-like nano-carbon material produced with the method and apparatus is free of any residual surfactant.

To achieve the above and other objects, the multilayer film structure according to the present invention is obtained by sequentially growing a first oxide layer, a catalyst layer, and a second oxide layer on a first substrate from bottom to top. And, the catalyst layer of the multilayer film structure is converted into a nano-carbon material layer by chemical vapor deposition for use in subsequent processes.

Alternatively, the multilayer film structure according to the present invention is obtained by sequentially growing a first oxide layer, a nano-carbon material layer, and a second oxide layer on a first substrate from bottom to top. the nano-carbon material layer is converted from and grown on a catalyst layer that is pre-provided between the first and the second oxide layer by chemical vapor deposition. And, the nano-carbon material is a carbon nanotube, a diametrical size of which can be controlled via a pore density of the second oxide layer.

To achieve the above and other objects, the method for transferring nano-carbon material according to the present invention includes the steps of growing a multilayer film structure on a first substrate; etching away undesired portions of the multilayer film structure through a wet etching process to obtain a separated film-like nano-carbon material, which floats on the etchant; using a continuous conveyance apparatus to pull out and clean the film-like nano-carbon material; and transferring the cleaned film-like nano-carbon material to a second substrate. Therefore, the film-like nano-carbon material separated from the first substrate can be quickly transferred to the second substrate in large area without any residual surfactant left thereon.

To achieve the above and other objects, the apparatus for transferring nano-carbon material according to the present invention includes an etching device for etching away undesired portions of a multilayer film structure to separate a nano-carbon material from a first substrate; at least one continuous conveyance device for quickly and continuously removing the separated nano-carbon material from an etching bath of the etching device and transferring the nano-carbon material to a second substrate; and a cleaning device arranged between two continuous conveyance devices for removing any residual etchant from the nano-carbon material separated from the etching bath and thereby cleaning the nano-carbon material before the latter is transferred to the second substrate. With the above arrangements, large area film-like nano-carbon material can be quickly and continuously transferred in large scale without leaving any residual surfactant thereon to thereby overcome the problem in the prior art.

In brief, the multilayer film structure, and the method and apparatus for transferring nano-carbon material according to the present invention have one or more of the following advantages:

(1) The film-like nano-carbon material grown on the multilayer film structure of the present invention is separated from other undesired portions by a wet etching process to avoid any change in the electric conductivity, light transmission, and thermal stability of the nano-carbon material caused by any residual solvent and surfactant. And, the film-like nano-carbon material so obtained is purified and chemically modified.

(2) The method for transferring nano-carbon material according to the present invention combines the film-like nano-carbon material on the multilayer film structure with the wet etching process to enable quick and continuous transfer of large area film-like nano-carbon material.

(3) The apparatus for transferring nano-carbon material according to the present invention includes continuous conveyance devices to achieve large-scale and continuous transfer of the film-like nano-carbon material from a first to a second substrate.

(4) The method for transferring nano-carbon material according to the present invention can further include a masking process to achieve multilayer stacking and patterned imprinting of the film-like nano-carbon material on the second substrate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing a multilayer film structure according to the present invention;

FIG. 2 is a schematic view showing a first stage of etching in a process of separating a nano-carbon material from a substrate according to the present invention;

FIG. 3 is a schematic view showing a second stage of etching in a process of separating a nano-carbon material from a substrate according to the present invention;

FIG. 4 is a schematic view showing an apparatus according to the present invention for continuously transferring a nano-carbon material; and

FIG. 5 is a schematic view showing a process for imprinting the nano-carbon material of the present invention to a substrate.

### DETAILED DESCRIPTION OF THE PREFERRED EMBODIMENTS

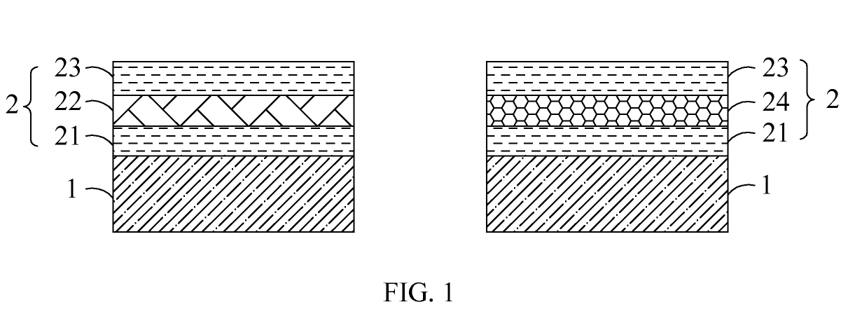

Please refer to FIG. 1 that is a conceptual view showing a multilayer film structure according to the present invention. As shown at the left of FIG. 1, the multilayer film structure 2 of the present invention is formed on one side of a first substrate 1, and includes a first oxide layer 21, a catalyst layer 22, and a second oxide layer 23 sequentially formed on the first substrate 1 from bottom to top.

To form the multilayer film structure 2, first grow the first oxide layer 21 on one side of the first substrate 1 through chemical vapor deposition (CVD). The first oxide layer 21 is a silicon oxide layer. Then, the catalyst layer 22 and the second oxide layer 23 are sequentially grown on the first oxide layer 21 through E-gun evaporation. The catalyst layer 22 is a nickel metal layer, and the second oxide layer 23 is a silicon oxide layer. Thereafter, use the CVD process and introduce alcohol vapor into the multilayer film structure 2 as a carbon source precursor for growing a nano-carbon material, so that a film-like nano-carbon material 24 is grown at a temperature between 650° C. and 950° C., preferably at 800° C. As shown at the right of FIG. 1, the film-like nano-carbon material 24 starts growing in the catalyst layer 22 to uniformly interlace with one another and thereby form a film between the first and the second oxide layer 21, 22. The film so formed presents a net structure. In the present invention, the nano-carbon material 24 is a carbon nanotube. However, some part of the nano-carbon material 24 will go through the porous second oxide layer 23 to also form the film-like nano-carbon material along one side of the second oxide layer 23 facing away from the nano-carbon material 24. On the other hand, since the first oxide layer 21 is in direct contact with the first substrate 1, there is not sufficient room between the first oxide layer 21 and the first substrate 1 for growing the nano-carbon material 24, and the nano-carbon material 24 would not penetrate the first oxide layer 21 to grow. Further, it is able to control a diametrical size of the grown nano-carbon material, i.e. the carbon nanotube, via a pore density of the second oxide layer 23; and the pore density of the second oxide layer 23 can be controlled by regulating a deposition rate of the second oxide layer 23.

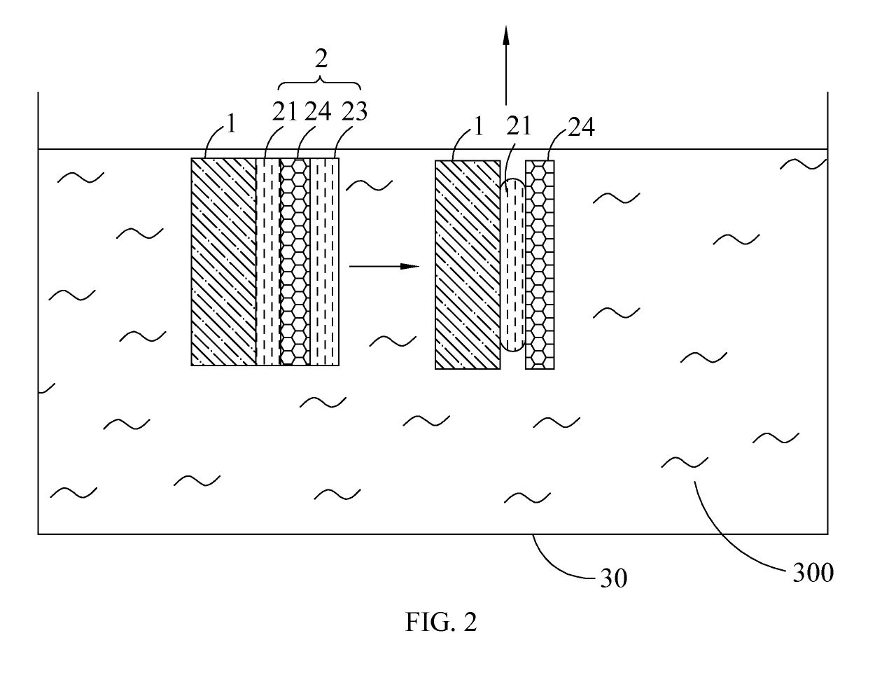

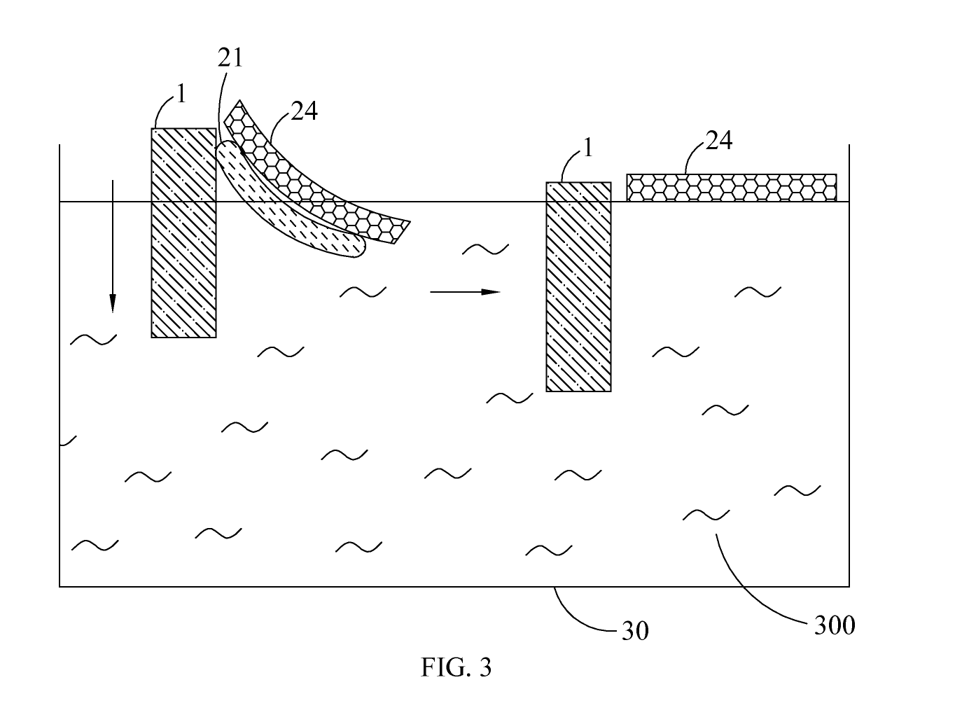

Please refer to FIG. 2 that is a schematic view showing a first stage of etching in a process of separating the nano-carbon material 24 of the present invention from the first substrate 1. As shown at the left of FIG. 2, when the process of growing the film-like nano-carbon material 24 is completed, the first substrate 1 with the multilayer film structure 2 grown thereon is vertically dipped into an etching bath 30 for the first time. In the etching bath 30, an etchant 300 is contained. The etchant 300 is a type of buffer oxide etch (BOE) formed from a mixed solution of hydrogen fluoride (HF) and ammonium fluoride (NH₄F). In this process, the first oxide layer 21 and the second oxide layer 23 are subjected to a first stage of etching for about 70 to 110 seconds, preferably 90 seconds. When the above etching time has lapsed, the second oxide layer 23 is completely etched away by the etchant 300. However, since the first oxide layer 21 has only a small area exposed to the etchant 300 compared to the second oxide layer 23, there is still part of the first oxide layer 21 remained on the first substrate 1 without being etched, as shown at the right of FIG. 2. That is, the film-like nano-carbon material 24 is still attached to the remaining first oxide layer 21. At this point, the first substrate 1 with the remaining first oxide layer 21 and the film-like nano-carbon material 24 attached to the first oxide layer 21 is pulled out of the etchant 300, and is then slowly vertically dipped into the etchant 300 for a second time, so as to proceed with a second stage of etching. Please refer to FIG. 3. As shown at the left of FIG. 3, when the first substrate 1 along with the remaining first oxide layer 21 and the film-like nano-carbon material 24 have been dipped into the etchant 300 for the second time, the film-like nano-carbon material 24 will naturally separate from the first substrate 1 to float on a surface of the etchant 300 during the second stage of etching. The second stage of etching continues for about 100 to 140 seconds, preferably 120 seconds, and as shown at the right of FIG. 3, the remaining first oxide layer 21 is now completely etched away by the etchant 300. At this point, the film-like nano-carbon material 24 can be removed from the etching bath 30.

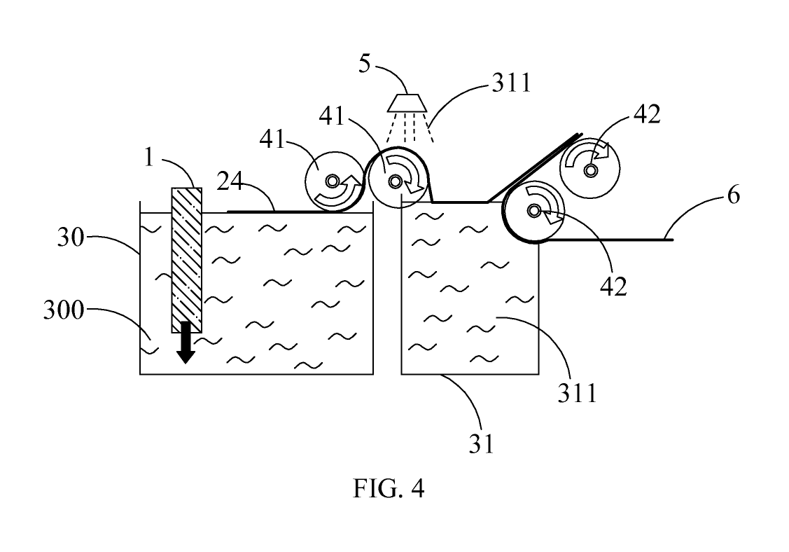

Please refer to FIG. 4 that is a schematic view showing an apparatus according to the present invention for continuously transferring a nano-carbon material. As shown, the nano-carbon material transferring apparatus according to the present invention includes an etching bath 30, a cleaning bath 31, a first continuous conveyance device 41, a second continuous conveyance device 42, and a cleaning device 5. The first and the second continuous conveyance device 41, 42 each include a plurality of rolls. The first continuous conveyance device 41 is arranged at one side of the etching bath 30 and one side of the cleaning bath 31 adjacent to the etching bath 30, and connects the etching bath 30 with the cleaning bath 31 for removing the film-like nano-carbon material 24 out of the etching bath 30. The cleaning device 5 is a nozzle arranged between the first continuous conveyance device 41 and the cleaning bath 31 for spraying a cleaning solution 311 onto the film-like nano-carbon material 24, in order to remove any residual etchant 300 from the film-like nano-carbon material 24. The second continuous conveyance device 42 is arranged at an opposing side of the cleaning bath 3 opposite the first continuous conveyance device 41 for removing the film-like nano-carbon material 24 out of the cleaning bath 31 and then transferring and attaching the film-like nano-carbon material 24 to a second substrate 6. The cleaning bath 31 contains the cleaning solution 311 therein for removing any residual etchant 300 from the nano-carbon material 24.

When the film-like nano-carbon material 24 is dipped into the etching bath 30 for the second time to etch away the remaining first oxide layer 21 in the second stage of etching, the etching continues for about 100 to 140 seconds, preferably 120 seconds, to thereby completely etch away the remaining first oxide layer 21. The film-like nano-carbon material 24 alone floats on the etchant 300 in the etching bath 30 and is then pulled up into the first continuous conveyance device 41 by the rolls thereof. While the film-like nano-carbon material 24 is moved through the rolls of the first continuous conveyance device 41, the cleaning device 5 sprays the cleaning solution 311 onto the film-like nano-carbon material 24. In the present invention, the cleaning solution 311 is deionized water (DI water). The film-like nano-carbon material 24 having been sprayed by the cleaning solution 311 is further moved by the first continuous conveyance device 41 into the cleaning bath 31, in which more cleaning solution 311 is contained, so as to remove any residual etchant 300 from the film-like nano-carbon material 24. Through the etching and cleaning processes, the film-like nano-carbon material 24 is purified and can float on the cleaning solution in the cleaning bath 31 in a complete state. The purified film-like nano-carbon material 24 in the cleaning bath 31 is then pulled up into the second continuous conveyance device 42 by the rolls thereof and is attached to one face of the second substrate 6, which has already been wound at an opposing face around the rolls of the second continuous conveyance device 42. In the present invention, the second substrate 6 is a flexible polymeric substrate, and can be selected from the group consisting of polyethylene terephthalate (PET), polyvinyl chloride (PVC), polyethylene (PE), polystyrene (PS), and a composite material.

The above described process of transferring the film-like nano-carbon material 24 using the first and the second continuous conveyance device 41, 42 is also referred to as a Roll-to-Roll process. With this process, large-area film-like nano-carbon material 24 can be transferred from the first substrate 1 to the second substrate 6 in a large-scale and continuous manner.

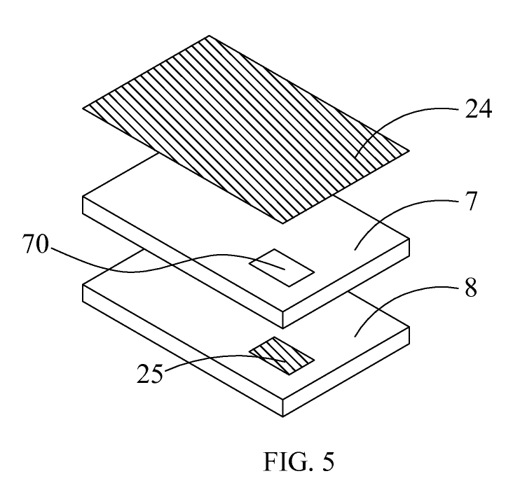

FIG. 5 is a schematic view showing a process for imprinting the nano-carbon material according to the present invention to a substrate. As shown, in the imprinting process, a masking plate 7 and a second substrate 8 are prepared. The masking plate 7 is a flat steel plate being formed with at least one opening 70, through which the film-like nano-carbon material 24 can be imprinted onto the second substrate 8, which can be selected from the group consisting of glass, copper foil, and various polymeric substrates to provide a variety of choices to users.

A plurality of masking plates 7 can be prepared with the opening 70 formed on each of them being differently shaped and located. The film-like nano-carbon material 24 can pass through the differently shaped and located openings 70 and be imprinted onto the second substrate 8 to show a particularly designed pattern thereon. As shown, the imprinted nano-carbon materials 25 on the second substrate 8 not only have shape and size the same as that of the openings 70 formed on the masking plates 7, but also have optical and electric properties the same as that of the film-like nano-carbon material 24. Therefore, with the imprinting method of the present invention, the process of patterned imprinting of the high-quality film-like nano-carbon material onto the second substrate 8 can be accomplished.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multilayer film structure, comprising:
a first oxide layer being connected to one side of a first substrate;
a catalyst layer being connected to one side of the first oxide layer opposite to the first substrate; and
a second oxide layer being connected to one side of the catalyst layer opposite to the first oxide layer;
wherein the multilayer film structure provides a preparatory structure for growing a nano-carbon material thereon, and the nano-carbon material is grown in the catalyst layer through conversion of the catalyst layer by chemical vapor deposition.

2. The multilayer film structure as claimed in claim 1, wherein the nano-carbon material is a carbon nanotube.

3. The multilayer film structure as claimed in claim 2, wherein the first oxide layer and the second oxide layer each are a silicon oxide layer.

4. The multilayer film structure as claimed in claim 3, wherein the grown carbon nanotube has a diametrical size controllable via a pore density of the second oxide layer.

5. The multilayer film structure as claimed in claim 1, wherein the catalyst layer is a nickel metal layer.

6. The multilayer film structure as claimed in claim 1, wherein the chemical vapor deposition is performed at a working temperature ranged from 650 to 950° C.

7. The multilayer film structure as claimed in claim 6, wherein the chemical vapor deposition is performed at a working temperature of 800° C.

8. A multilayer film structure, comprising:
a first oxide layer being connected to a first substrate;
a nano-carbon material being connected to one side of the first oxide layer opposite to the first substrate; and
a second oxide layer being connected to one side of the nano-carbon material opposite to the first oxide layer;
wherein the nano-carbon material is grown in a catalyst layer pre-provided between the first and the second oxide layer through conversion of the catalyst layer by chemical vapor deposition.

9. The multilayer film structure as claimed in claim 8, wherein the nano-carbon material is a carbon nanotube.

10. The multilayer film structure as claimed in claim 9, wherein the first oxide layer and the second oxide layer each are a silicon oxide layer.

11. The multilayer film structure as claimed in claim 10, wherein the grown carbon nanotube has a diametrical size controllable via a pore density of the second oxide layer.

12. The multilayer film structure as claimed in claim 8, wherein the catalyst layer is a nickel metal layer.

13. The multilayer film structure as claimed in claim 8, wherein the chemical vapor deposition is performed at a working temperature ranged from 650 to 950° C.

14. The multilayer film structure as claimed in claim 13, wherein the chemical vapor deposition is performed at a working temperature of 800° C.

15. A method for transferring nano-carbon material, comprising the steps of:
using an etchant to simultaneously etch a first oxide layer and a second oxide layer of a multilayer film structure at a first stage of etching;
using the etchant to further etch the first oxide layer of the multilayer film structure at a second stage of etching;
removing any residual etchant from a nano-carbon material of the multilayer film structure; and
transferring the nano-carbon material to a second substrate;
wherein the first oxide layer, the nano-carbon material, and the second oxide layer of the multilayer film structure are sequentially grown on a first substrate from bottom to top.

16. The method for transferring nano-carbon material as claimed in claim 15, wherein the nano-carbon material is a carbon nanotube.

17. The method for transferring nano-carbon material as claimed in claim 16, wherein the first oxide layer and the second oxide layer each are a silicon oxide layer.

18. The method for transferring nano-carbon material as claimed in claim 17, wherein the grown carbon nanotube has a diametrical size controllable via a pore density of the second oxide layer.

19. The method for transferring nano-carbon material as claimed in claim 15, further comprising an imprinting process for imprinting the nano-carbon material onto the second substrate.

20. The method for transferring nano-carbon material as claimed in claim 19, wherein the imprinting process uses a masking plate to define an imprinted pattern.

21. The method for transferring nano-carbon material as claimed in claim 20, wherein the second substrate is selected from the group consisting of a flexible substrate and a rigid substrate.

22. The method for transferring nano-carbon material as claimed in claim 21, wherein the second substrate is selected from the group consisting of polyethylene terephthalate (PET), polyvinyl chloride (PVC), polyethylene (PE), polystyrene (PS), transparent glass, copper foil, and a composite material.

23. The method for transferring nano-carbon material as claimed in claim 15, further comprising a roll-to-roll process for imprinting the nano-carbon material to the second substrate.

24. The method for transferring nano-carbon material as claimed in claim 23, wherein the second substrate is a flexible substrate.

25. The method for transferring nano-carbon material as claimed in claim 24, wherein the second substrate is selected from the group consisting of polyethylene terephthalate (PET), polyvinyl chloride (PVC), polyethylene (PE), and polystyrene (PS).

26. The method for transferring nano-carbon material as claimed in claim 15, wherein the etchant is a buffer oxide etch (BOE).

27. The method for transferring nano-carbon material as claimed in claim 26, wherein the first stage of etching for simultaneously etching the first and the second oxide layer continues for a period of time from 70 to 110 seconds.

28. The method for transferring nano-carbon material as claimed in claim 27, wherein the first stage of etching continues for 90 seconds to completely etch away the second oxide layer.

29. The method for transferring nano-carbon material as claimed in claim 26, wherein the second stage of etching for etching only the first oxide layer continues for a period of time from 100 to 140 seconds.

30. The method for transferring nano-carbon material as claimed in claim 29, wherein the second stage of etching continues for 120 seconds to completely etch away the first oxide layer.

31. The method for transferring nano-carbon material as claimed in claim 15, wherein in the step of removing any residual etchant from the nano-carbon material, deionized water is used to remove the residual etchant.

32. An apparatus for transferring nano-carbon material, comprising:
an etching device for etching away a first oxide layer and a second oxide layer of a multilayer film structure; the multilayer film structure including the first oxide layer, a nano-carbon material, and the second oxide layer sequentially grown on a first substrate from bottom to top;
at least one continuous conveyance device including:
a first continuous conveyance device for continuously conveying the nano-carbon material; and
a second continuous conveyance device for continuously conveying the nano-carbon material and transferring the same to a second substrate; and
a cleaning device for cleaning the nano-carbon material;
wherein the first continuous conveyance device is arranged at one side of the etching device and one side of the cleaning device adjacent to the etching device to connect the etching device with the cleaning device, and the second continuous conveyance device is arranged at an opposing side of the cleaning device opposite to the etching device.

33. The apparatus for transferring nano-carbon material as claimed in claim 32, wherein the nano-carbon material is a carbon nanotube.

34. The apparatus for transferring nano-carbon material as claimed in claim 32, wherein the first oxide layer and the second oxide layer each are a silicon oxide layer.

35. The apparatus for transferring nano-carbon material as claimed in claim 33, wherein the grown carbon nanotube has a diametrical size controllable via a pore density of the second oxide layer.

36. The apparatus for transferring nano-carbon material as claimed in claim 32, wherein the etching device further includes an etching bath for containing an etchant therein.

37. The apparatus for transferring nano-carbon material as claimed in claim 32, wherein the continuous conveyance device is a roll-to-roll device.

38. The apparatus for transferring nano-carbon material as claimed in claim 32, wherein the cleaning device further includes a nozzle for spraying a cleaning solution to clean the nano-carbon material.

39. The apparatus for transferring nano-carbon material as claimed in claim 38, wherein the cleaning device further includes a cleaning bath for containing a cleaning solution therein.

40. The apparatus for transferring nano-carbon material as claimed in claim 37, wherein the second substrate is selected from the group consisting of polyethylene terephthalate (PET), polyvinyl chloride (PVC), polyethylene (PE), polystyrene (PS), and a composite material.
